(19) United States
(12) Patent Application Publication
(10) Pub. No.: US 2009/0025593 A1
(43) Pub. Date: Jan. 29, 2009

(54) PRINTING PRESS

(75) Inventors: Stuart Michael Gahan, Lancashire (GB); Tony Hollings, Lancashire (GB); Wesley Clements, Lancashire (GB)

Correspondence Address: LOWRIE, LANDO & ANASTASI, LLP, ONE MAIN STREET, SUITE 1100, CAMBRIDGE, MA, 02142, US

(73) Assignee: GOSS GRAPHIC SYSTEMS LIMITED, Preston, Lancashire, GB (GB)

(21) Appl. No.: 11/913,634

(22) PCT Filed: Apr. 5, 2006
(86) PCT No.: PCT/EP2006/061325

§ 371 Date: Oct. 7, 2008

(30) Foreign Application Priority Data
Aug. 4, 2005 (GB) 0515988.4

(51) Int. Cl. B41F 27/12

(52) U.S. Cl. 101/477

(57) ABSTRACT

A method of controlling a printing unit is disclosed. The printing unit comprising a plurality of printing couple pairs, each printing couple pair comprising a plate cylinder and a blanket cylinder and an inking system associated with each printing couple pair operable to supply ink to printing plates mounted on the plate cylinders of said printing couple pairs. The printing unit also comprises a primary module carrying the printing couple pairs and, a pair of secondary modules carrying the inking systems, the secondary modules being movable relative to the primary module from an operative into a non-operative position in which each secondary module is separated from the primary module. The printing unit further comprises apparatus for loading/unloading printing plates from the plate cylinders of the printing unit and the method includes the step of unloading printing plates from the plate cylinders of the printing unit using said apparatus whilst the secondary modules are moving relative to the primary modules into their non-operative positions.

The present invention relates to a printing press and to a method controlling a printing press to improve the loading of printing plates onto, and the removal of printing plates from, the plate cylinders of the press.

A web offset printing press comprises a number of printing units. Each unit is designed to print matter onto a continuous web of paper as it travels through the print unit. The printed web emerging from each print unit come together in a folding unit which orientates, folds and cuts each web to produce the finished article such as a newspaper or magazine. Each unit contains at least one pair of cylinder groups or print couples comprising a rotatably mounted plate cylinder, to which one or more printing plates are attached and, a rotatably mounted blanket cylinder. The printing unit may incorporate a shaft less drive system in which each cylinder group is driven by its own drive motor that directly drives one of the cylinders of a group via a belt or gear drive and the other cylinder of that group is mechanically coupled to the driven cylinder. An inking system associated with each print couple is operable to feed ink onto the printing plates attached to the plate cylinder as the plate cylinder rotates. As the cylindrical surfaces of the plate and blanket cylinder are in rolling contact, an inked image is transferred from the printing plates onto the blanket cylinder and from the blanket cylinder onto the medium to be printed.

In large scale high volume presses used, for example, in the production of newspapers, multi-colour printing is achieved by providing each print unit with a number of printing couples arranged in pairs which are mounted vertically above one another in a stack so that the paper web travels in a vertically upward direction between each pair of print couples. A unit having four print couple pairs, i.e. eight print couples, is able to print up to four colours on each side of the paper web and is often referred to as a “four-high” unit.

When a press is prepared for a print run, at least one printing plate carrying the image to be printed must be firmly clamped to the plate cylinder of each print couple. Generally, the plate cylinder includes at least one recess or lock-up slot extending longitudinally along the surface of the plate cylinder and into which is received the leading and trailing edge of a printing plate. A clamping mechanism located in the recess engages the leading and trailing edges of an inserted printing plate and firmly holds the printing plate in position during a print run. The number of printing plates that must be attached to the plate cylinder of each print couple depends on the width of the press and whether the plate cylinder carries one or two printing plates around its circumference, i.e. whether it is a “one around” or “two around” plate cylinder. For example, in a double width one-around press, the plate cylinder may carry four printing plates across its width and one printing plate extending circumferentially around its cylindrical surface. Therefore, there could be as many as eight printing plates in a single printing couple pair and thirty-two printing plates in a four high printing unit all of which must be replaced before a new print run can be initiated. When the plate cylinder is of the “two-around” type, the number of printing plates is doubled accordingly. Therefore, it will be appreciated that even in the production of just one newspaper issue, a very large number of printing plates will be required.

It is of utmost importance to ensure that all the printing plates attached to one plate cylinder are located in very precise circumferential and lateral registration with respect to each other. It will also be appreciated that as ink of a different colour is applied to the print medium as it passes through each print couple pair of a print unit, it is also important that the printing plates are in alignment with the printing plates attached to each of the other plate cylinders of the press as any misalignment of a printing plate will result in mis-registration of the different coloured inks applied to the print medium which will reduce the quality of the final print.

To enable accurate location of the printing plates, precise detection and confirmation of the position of each printing plate must be determined during installation onto the plate cylinder. A commonly known method of aligning a printing plate on a plate cylinder and to make sure that it is located in an “in-register” position is to provide the leading edge of each plate with a number of slots that locate on pins in the recess in the plate cylinder into which the leading edge of the printing plate is received when it is attached to a plate cylinder. The position of the slots and pins are predetermined so that, when the pins have been located in the slots, the printing plate is in the correct position and the press operator can be confident that the printing plate will be positioned correctly in relation to other printing plates.

In a conventional printing machine, the press operator loads both the leading and trailing edges of each printing plate onto the plate cylinders manually so that they are accurately located in their predetermined in-register positions. However, it will be appreciated that this activity is very labour intensive and time consuming especially when a large number of printing plates need to be replaced. It also means that the press, or at least individual print units, are rendered inoperable for an extended period of time and this has a significantly detrimental affect on the overall productivity of the press.

In an attempt to reduce the setting-up time, attempts have been made to automate or partially automate the plate loading process in which printing plates are automatically fed onto, and accurately located on, the plate cylinder by a printing plate feeding mechanism attached to the printing unit. In such systems, the press operator either accurately positions the printing plates in printing plate holders fixed to the printing press adjacent to each of the plate cylinders of the press or, the position of the printing plates is established by position sensors or similar devices whilst the plates are fed onto the plate cylinder. It is also known from the Applicant's own co-pending GB application no. 0409594.9 to provide an improved automatic printing plate loading system that enables printing plates to be pre-positioned in an off-press location and then brought to the press and loaded onto the plate cylinders whilst their “in-register” positions are maintained. This application also describes a fully automatic plate loading module for lifting plates from their holder and loading them onto the plate cylinders of the press. The plate loading module described in the above-mentioned application can also be used to automatically remove used plates from the plate cylinders of the press.

Conventional automatic plate loading systems, such as those described above, are relatively complicated in their construction and the Applicant has addressed this issue, in their co-pending application no. 0509424.8, by providing a semi-automatic system for unloading printing plates from the plate cylinders of a press that although still involves operator input, significantly increases the speed and ease by which printing plates may be accurately and efficiently unloaded from the printing plate cylinders of a printing press. This apparatus also assists the operator during the plate loading process and overcomes or substantially alleviates many of the problems associated with manual plate loading procedures and avoids the need for complicated detection and position sensing equipment for detecting the position of the printing plates that is required by automatic and many of the conventional semi-automatic plate loading systems currently available.

The Applicant also has another co-pending application namely, GB 0408085.9, which describes a modular flexible offset press comprising print units that split into different modules to provide improved access to all parts of the unit for plating up and other tasks.

It will be appreciated that it is desirable to be able to unload/load printing plates on the plate cylinders of a printing press as quickly as possible so that the downtime during which the press is non-operational can be minimised. The printing plate loading and unloading system, described in GB0509424.8, and the modular printing press unit configuration, described in GB0408085.9, both help to achieve a faster plating-up time than has conventionally been the case.

However, it is desirable to speed up the plate loading and/or unloading process even further.

The present invention seeks to improve plating-up, and plate removal, times by combining aspects of the modular printing press configuration and the semi-automatic plate loading systems that have previously been developed.

According to the present invention, there is provided a method of controlling a printing unit comprising a plurality of printing couple pairs, each printing couple pair comprising a plate cylinder and a blanket cylinder and an inking system associated with each printing couple pair operable to supply ink to printing plates mounted on the plate cylinders of said printing couple pairs, the printing unit comprising a primary module carrying the printing couple pairs and, a pair of secondary modules carrying the inking systems, the secondary modules being movable relative to the primary module from an operative into a non-operative position in which each secondary module is separated from the primary module, the printing unit further comprising apparatus for loading/unloading printing plates from the plate cylinders of the printing unit, wherein the method includes the step of unloading printing plates from the plate cylinders of the printing unit using said apparatus whilst the secondary modules are moving relative to the primary modules into their non-operative positions.

Each printing plate preferably has a leading and trailing edge which locate in respective lock-up slots in the plate cylinders and the method preferably includes the step of unloading printing plates from the plate cylinders of the printing unit by:
(a) extracting the trailing edge of the printing plates from a lock-up slot in the plate cylinder;
(b) partially extracting the leading edge from a lock up slot of a plate cylinder and,
(c) rotating the plate cylinder so that an extraction member engages a portion of the leading edge of the printing plate protruding from the lock up slot following its partial extraction, to remove the printing plate from the plate cylinder and leave the removed plate, hanging by its leading edge, on the extraction member.

In a preferred embodiment, the removed plates are left hanging from the extraction member by the time separation of the secondary module from the primary module is complete and the secondary modules are in their non-operative positions.

A preferred method of the invention may also include the step of rotating the plate cylinders into a predetermined position following removal of the printing plates therefrom to facilitate the mounting of a further set of printing plates thereto prior to movement of the secondary modules back into their operative position with the primary module.

The mounting of a further set of printing plates preferably includes the step of manually inserting the leading edge of the printing plates into leading edge lock up slots in the plate cylinders and operating the printing plate loading/unloading apparatus to insert the trailing edge into the trailing edge lock up slots.

In a particularly preferred embodiment the method includes the step of operating the printing plate loading/unloading apparatus to insert the trailing edge of the printing plates into their respective trailing edge lock up slots as the secondary modules move back into their operative positions with the primary module so that the loading of printing plates onto the plate cylinders is completed by the time the secondary modules have reached their operative positions.

According to the present invention, there is also provided a printing unit comprising a plurality of printing couple pairs, each printing couple pair comprising a plate cylinder and a blanket cylinder and an inking system associated with each printing couple pair operable to supply ink to printing plates mounted on the plate cylinders of said printing couple pairs, the printing unit comprising a primary module carrying the printing couple pairs and, a pair of secondary modules carrying the inking systems, the secondary modules being movable relative to the primary module from an operative into a non-operative position in which each secondary module is separated from the primary module, the printing unit further comprising apparatus for loading/unloading printing plates from the plate cylinders of the printing unit, wherein the printing unit includes control means operable to initiate operation of the apparatus for loading/unloading printing plates from the plate cylinders of the printing unit to unload printing plates therefrom when the secondary modules move relative to the primary module into their non-operative positions.

In a preferred embodiment, the printing plates each have leading and trailing edges located in lock-up slots in the plate cylinders and the apparatus for loading/unloading printing plates comprising means for partially extracting the leading edge of a printing plate from a lock-up slot subsequent to extraction of trailing edge from its lock up slot and, an extraction member for engaging, as the printing cylinder rotates, a portion of the leading edge of the printing plate protruding from the lock up slot following its partial extraction, to complete the removal of the printing plate from the printing cylinder and leave the unloaded plate, hanging by its leading edge, on the extraction member.

The apparatus may be configured so that unloaded printing plates are hanging from the extraction member by the time separation of the secondary modules from the primary module is complete.

In one embodiment, the control means is configured to rotate the plate cylinders into a predetermined position following unloading of the printing plates to facilitate the mounting of a further set of printing plates thereto prior to movement of the secondary modules back into their operative position with the primary module.

The control means is preferably operable to control the printing plate loading/unloading apparatus to insert the trailing edge of the printing plates into the trailing edge lock up slot following manual insertion of the leading edge a leading edge lock up slot.

The control means is preferably operable to initiate operation of the printing plate loading/unloading apparatus, to insert the trailing edge of the printing plates into their respective trailing edge lock up slots, as the secondary modules move back into their operative positions with the primary module.

Embodiments of the invention will now be described, by way of example only, and with reference to the accompanying drawings, in which:

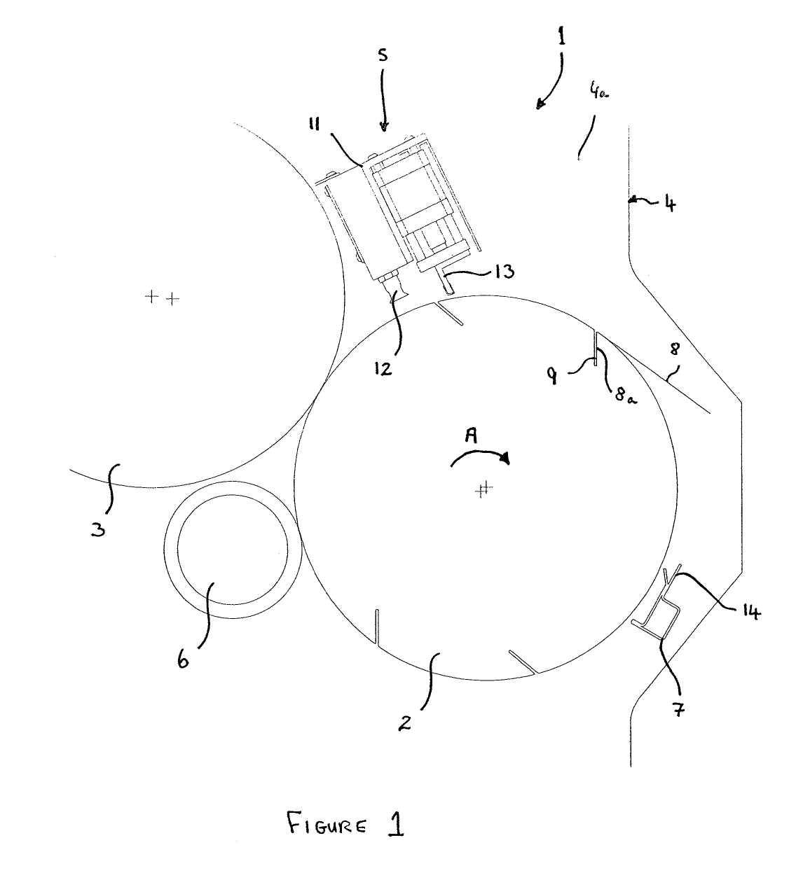

FIG. 1 is a schematic side sectional view through a portion of the primary module to illustrate a plate cylinder, part of a blanket cylinder of one print couple and plate loading apparatus including a plate loading head;

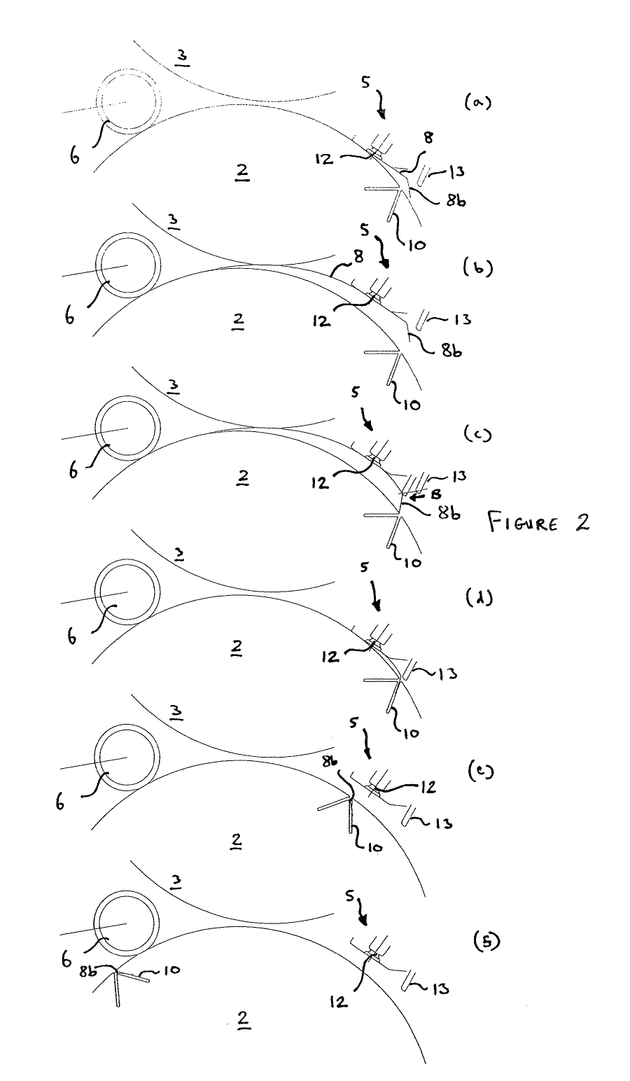

FIG. 2a to 2f is a sequence of drawings to illustrate how the apparatus shown in FIG. 1 may be used to assist in the printing plate loading procedure and, more specifically to insert the trailing edge of a printing plate into its corresponding lock-up slot;

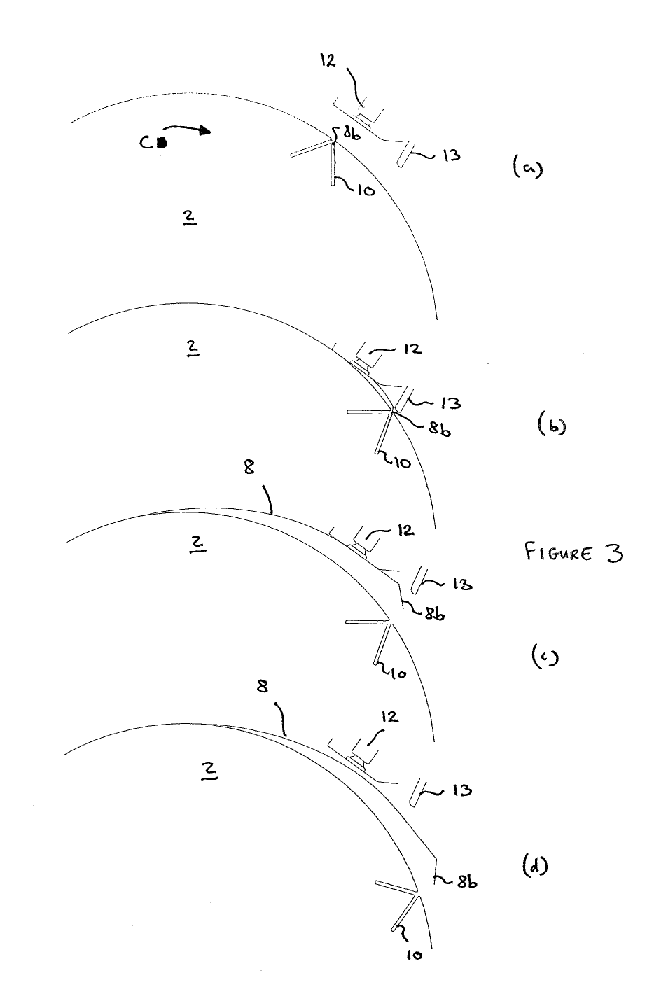

FIG. 3a to 3d is a sequence of drawings to illustrate how a plate loading/unloading apparatus may be used to remove the trailing edge of the printing plate from the lock up slot in which it is inserted;

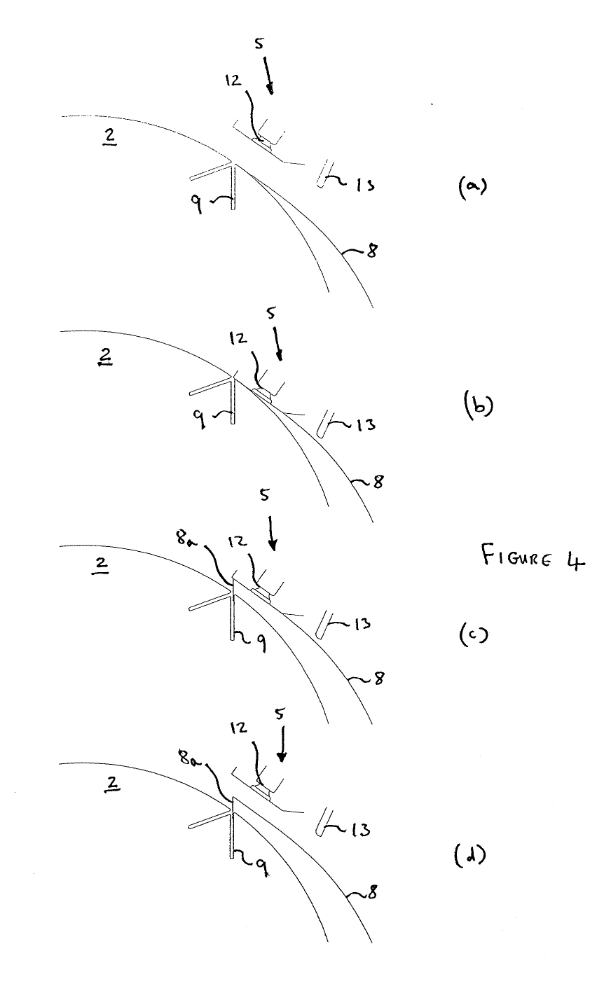

FIG. 4a to 4d is a sequence of drawings to illustrate how the apparatus may be used to partially remove the lead edge of a printing plate from the lock-up slot in which it was manually inserted during a loading procedure, and

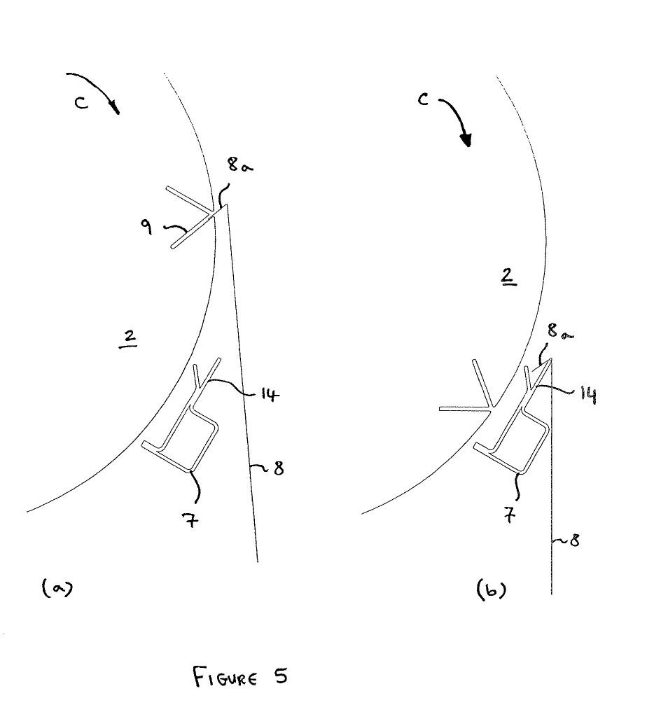

FIGS. 5a and 5b shows how the printing plate, with its lead edge partially removed from its corresponding lock-up slot, is stripped off the plate cylinder using the stripper bar.

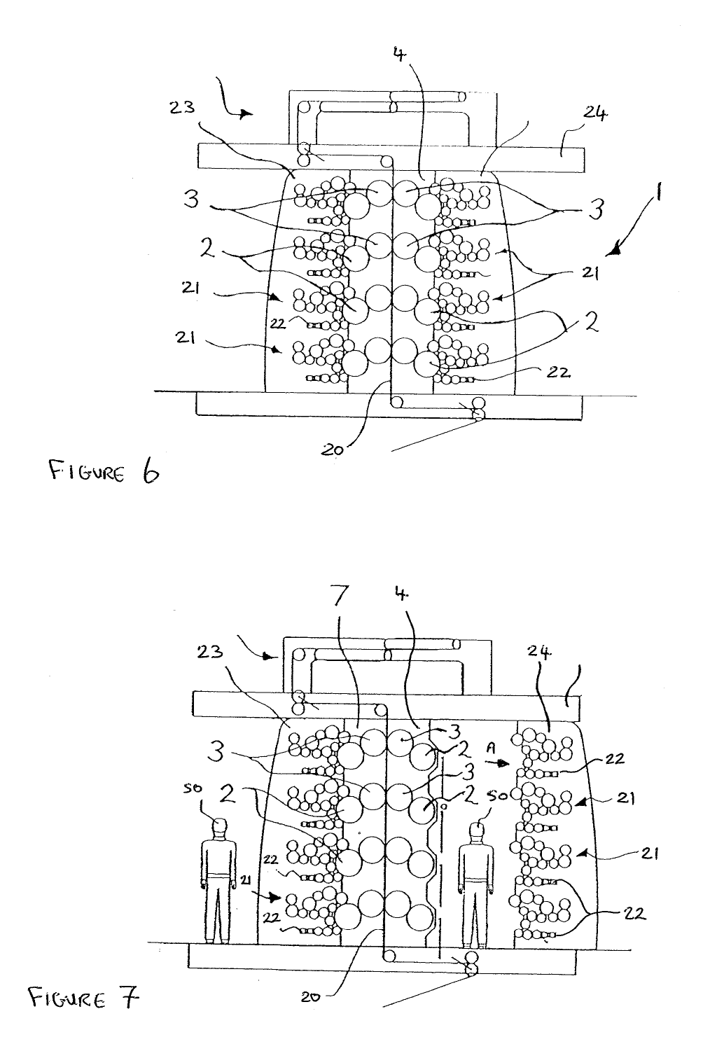

FIG. 6 illustrates a side cross-sectional elevation of a printing unit formed from a primary and a pair of secondary modules, in a closed or operative position ready for printing;

FIG. 7 illustrates a side cross-sectional elevation of the printing unit shown in FIG. 6 but in a partially open non-operative position to provide access and thereby facilitate plating-up operations and other tasks.

Referring now to the drawings, there is shown in FIG. 1 a side-sectional view of a portion of a primary or central module 4 of a printing unit 1 of a rotary web offset printing press showing the plate and blanket cylinders 2,3 of one cylinder group or print couple mounted within a frame 4a forming part of the primary module 4. Each print unit 1 of the press includes multiple cylinder groups. However, as each cylinder group is the same as that shown in FIG. 1, it is sufficient for understanding of the invention for only one such group to be illustrated and described in detail.

The plate loading apparatus of the invention comprises three main components mounted around each plate cylinder 2 namely, a plate loading/unloading head 5, a pressure roller 6 and, a static plate leading edge extraction bar or “stripper” bar 7. The plate loading/unloading head 5 can be moved using air cylinders (not shown) between a raised position in which it is spaced away from the plate cylinder when no plate unloading or loading operations are being performed and the printing unit 1 is in use and, a lowered position for carrying out plate loading or unloading operations on the plate cylinder 2. It will be appreciated that, for a complete 4 high printing tower, 8 sets of assemblies are required, one for each print couple. The plate loading/unloading head 5 also has an intermediate position, between the raised and lowered positions, to facilitate the removal of used printing plates 8 from the plate cylinder 2 and, more specifically, the extraction of the lead edge 8a of each printing plate from the lock-up slot 9 in which it is inserted, as will be explained in more detail below.

The plate loading/unloading head 5 includes an elongate support frame 11 that extends substantially across the entire width of the plate cylinder 2. An array of suction cups 12 are mounted to and depend from the support frame 11 so as to face the plate cylinder 2 and, when activated, are operable to engage the surface of a set of printing plates to enable the printing plates 8 to be manipulated by the plate loading/unloading head 5. The plate loading/unloading 5 head also includes a pusher element 13 depending from the support frame 11 adjacent to and in the same direction as the suction cups 12. The pusher element 13 is independently movable relative to the support frame 11 and to the suction cups 12 in a direction towards and away from the plate cylinder 2.

In a preferred embodiment of the invention, the pressure roller 6 is separate to the plate loading/unloading head 5 and also extends across the length of the plate cylinder 2. The pressure roller 6 may also be moved into and out of engagement with the plate cylinder 2 and rotates together with the plate cylinder 2 when in engagement therewith. The pressure roller 6 or the plate cylinder 2 to blanket cylinder 3 impression nip ensures that the leading and trailing edges 8a, 8b of any printing plates 8 located on the plate cylinder 2 are pushed fully home into their lock-up slots 9,10.

The extraction bar 7, extends across the width of the plate cylinder 2 close to, but spaced from, the surface thereof for reasons that will become apparent. The position of the extraction bar 7 is fixed and it has a lip or upwardly depending wall 14 upstanding from an upper longitudinally extending edge.

Before describing the function and operation of the aforementioned components and the procedures involved in the loading of one or more printing plates 8 onto, or the removal of one or more printing plates 8 from, the plate cylinder 2, the configuration of the print unit 1 will first be described in more detail.

Referring now to FIG. 6, there is shown a side cross-sectional elevation of a printing unit 1 which is illustrated in its operative or printing position ready for use. A web offset press of the invention may comprise one or several of these units each aligned so as to work in unison with a paper web passing through each printing unit 1 into a folder (not shown).

The illustrated printing unit 1 is of a four-high configuration for four colour printing on both sides of the web 20. It therefore has eight print couples each comprising a plate cylinder 2 and a blanket cylinder 3, of which only one is shown in FIG. 1. Each print couple is arranged in a pair disposed on opposite sides of the paper web 20 which runs between them so that the web 20 can be printed on both sides at the same time as it passes up through the print unit 1 from a reelstand (not shown) which may be mounted below or to one side of the print unit 1 at floor level.

An inking system 21 and a dampening system 22 is operatively associated with each print couple or, more specifically, the plate cylinder 2 of each print couple so as to supply ink and dampening solution thereto for printing. The inking and dampening systems 21,22 each comprises a train of rollers including forme rollers and ink distribution rollers. As the inking and dampening systems 21,22 are well known, no further description of their construction need be made here.

The printing unit 1 comprises a primary or central module 4 disposed between a pair of secondary or outer modules 23,24. As can be most clearly seen from FIG. 7, which illustrates the printing unit 1 of FIG. 6 in a non-operative partially open configuration for plate changing or maintenance, the plate and blanket cylinders 2,3 are rotatably mounted to the primary module 4 and the inking and dampening systems 21,22 are mounted to each of the secondary modules 23,24. Ideally, few other components apart from the plate and blanket cylinders 2,3 are mounted to the primary module 4.

As can be seen from FIG. 7, the secondary modules 23,24 are movably mounted so that they may retract or slide laterally away from the primary module 4 and so that the axis of the cylinders 2,3 mounted to the primary module remains parallel to the axis of the rollers of the inking and dampening systems 21,22 mounted to the secondary modules 23,24 but the axis-to-axis distance between them increases as the secondary modules 23,24 are moved laterally away from the primary module 4. However, only one secondary module 24 is shown retracted from the primary module 4 in FIG. 7, but it will be appreciated that the other secondary module 23 may also retract to facilitate access to that side of the printing unit 1 as well.

As can be seen from the representation of a person 50 standing between the retracted secondary module 24 and the primary module 4 in FIG. 7, the secondary modules 23,24 may retract laterally away from the primary module 4 by a distance which enables a person to walk between the secondary and primary modules 4,23,24 to carry out various tasks such as cleaning, maintenance or plating-up of the printing unit either to the plate and blanket cylinders 2,3 in the primary module 4 or, to the inking and/or dampening systems 21,22 of the secondary modules 23,24. To facilitate these operations, the press may include an integral lift platform (not shown) between each secondary module and the primary module which can rise to any height required to enable the whole printing unit to be serviced.

As the printing unit 1 opens up, it will be appreciated that access to all the components of the unit 1 is significantly improved.

Referring now to FIGS. 2 to 5, the procedure for loading/unloading printing plates 8 from the plate cylinders 2 will now be described. The print unit 1, or at least the pair of print couples for which the printing plates are to be loaded, are taken off-line. The plate cylinder 2 is then indexed forward by rotating it in the direction of arrow “A”, as shown in FIG. 1, so that the lock-up slot 9 for the leading edge 8a of the printing plate 8 is accessible to the operator. This pre-determined position which the plate cylinder assumes is generally indicated by the position of the plate cylinder 2 in FIG. 1. The lead edge 8a of the printing plates are now manually inserted into their lock up slots in the correct positions as guided by positioning pins in the slot and corresponding slots in the lead edge of the printing plate, as is conventional. Rotation of the plate cylinder in the direction of arrow “A” is then continued to wrap the printing plates 8 around the plate cylinder 2 and so that the lead edge 8a and lock-up slot 9 passes beneath the plate loading/unloading head 5 and beneath the pressure roller 6 which is in a lowered position so that it lies in contact with the surface of the plate cylinder 2. As the lead edge 8a passes beneath the pressure roller 6, pressure is applied to it by the pressure roller 6 to ensures that the lead edge 8a of the printing plate is pushed fully “home” into its lock up slot 9.

The plate cylinder continues to rotate until the lock-up slot 10 to receive the trailing edge 8b of the printing plate 8 is positioned substantially below the trailing edge 8a of the printing plate 8 which has now been fully wrapped around the plate cylinder 2, as shown in FIG. 2a. Next, the plate loading/unloading head 5 is lowered so that the suction cups 12 come into contact with the surface of the printing plate 8 adjacent to the trailing edge 8b, as also shown in FIG. 2a. The suction cups 12 are then activated to grasp the printing plate 8 and the plate loading/unloading head 5 is raised so as to lift the trailing edge 8b of the printing plate 8 off the plate cylinder 2, as shown in FIG. 2b. The pusher element 13 is then activated so that it moves in the direction indicated by arrow “B” so as to deflect the trailing edge 8b of the printing plate 8 inwardly towards the plate cylinder 2, as shown in FIG. 2c, and the plate loading/unloading head is then lowered again or the suction deactivated so that the trailing edge 8b of the plate 8 drops into its lock-up slot 10, as shown in FIG. 2d. The suction cups 12 are then deactivated to release the printing plate 8, the pusher element 13 is retracted and the plate loading/unloading head 5 is fully raised, as shown in FIG. 2e. Rotation of the plate cylinder 2 is then continued so that the trailing edge lock-up slot 10 passes beneath the pressure roller 6 or between the blanket cylinder 3 and plate cylinder 2 nip on impression to ensure that the trailing edge 8b of the printing plate is pushed fully “home” within its trailing edge lock-up slot 10, as shown in FIG. 2f. The pressure roller 6 is then retracted out of contact with the plate cylinder 2. The loading process is now complete and the printing couple may now be placed back on-line and a print run initiated.

The procedure for unloading printing plates 8 from the plate cylinder 2 will now be described. Removal of the trailing edge 8b of the printing plates 8 is essentially the reverse of the loading sequence. The plate cylinder 2 is initially indexed into a second predetermined position in which the trailing edge lock-up slot 10 is positioned close to the plate loading/unloading head, by rotating it in the direction of arrow “C”, as shown in FIG. 3a, so that it is once again in the same position as shown in FIG. 2a. The plate loading/unloading head 5 is subsequently lowered into contact with the upper surface of the printing plate 8 adjacent to its trailing edge 8b and the suction devices are then activated, as shown in FIG. 3b. The plate loading/unloading head 5 is then lifted so as to pull the trailing edge 8b of the printing plate 8 out of the lock-up slot 10, as shown in FIG. 3c. Once the trailing edge 8b of the printing plate 8 has been released from the lock-up slot 10, the suction cups 12 are deactivated to release the printing plate so that the plate cylinder 2 can be rotated in a direction indicated by arrow “C”, as shown in FIG. 3d, until the leading edge 8a of the printing plate 8 is positioned substantially beneath the plate loading/unloading head 5, as shown in FIG. 4a. As the plate cylinder 2 rotates, it will be appreciated that, due to the inherent resiliency and weight of the printing plate 8, the printing plate 8 springs out and away from the plate cylinder 2 so that the trailing edge is left hanging downwardly and extends over the extraction bar 7, the plate 8 being supported on the plate cylinder 2 only by engagement of the lead edge 8a in lock up slot 9.

When the leading edge lock up slot 9 is positioned substantially beneath the plate loading/unloading head 5, the head is lowered into contact with the surface of the printing plate 8 so that the suction cups 12 come into contact with the upper surface of the printing plate 8 adjacent to their leading edge 8a and the suction cups 12 are activated so as to engage the printing plate 8, as shown in FIG. 4b. Next, the head 5 is raised so as to lift the printing plate 8 off the plate cylinder 2. However, rather than raise the plate loading/unloading head 5 to its fully raised position, it is raised only to its intermediate position in which the leading edge 8a of the printing plate 8 is only partially, but not entirely, lifted out of its lock-up slot 9 in the plate cylinder 2, as shown in FIG. 4c. Once the intermediate position is reached, the suction cups 12 are deactivated. Although deactivation of the suction cups 12 releases the printing plate 8, the leading edge 8a of each plate 8 does not drop back into the lock up slot 9 and is held with its leading edge 8a only partially inserted in the lock-up slot, as shown in FIG. 4d.

To complete the unloading procedure, rotation of the plate cylinder is now continued in the direction of arrow “C”, as shown in FIG. 5a. As the plate cylinder 2 rotates, the leading edge lock up slot 9 approaches the extraction bar and the lip 14 on the extraction bar 7 engages or catches against part of the rear surface of the leading edge 8a of the printing plate 8 protruding from the lock up slot 9. As the plate cylinder 2 continues to rotate, the leading edge 8a of the printing plates 8 are lifted out of the lock up slot 9 and are hooked on the lip 14 of the extraction bar, as shown in FIG. 5b, thereby completely removing the printing plate 8 from the plate cylinder 2. The unloading process is now complete and the plate cylinder 2 is ready for a fresh set of printing plates 8 to be loaded thereon. The used plates 8 can be simply removed from the extraction bar 7 by manually lifting their leading edges 8a off the lip 14. It will be appreciated that, for example in a two around press, a first set of used plates 8 may remain hanging from the extraction bar 7 whilst another set is removed from the plate cylinder 2. The presence of a first set of used plates 8 hanging from the extraction bar 7 does not hinder the removal of a subsequent set. However, the first set of plates 8 may be manually removed prior to running the unload procedure for the second set, if preferred.

According to an embodiment of the present invention, the unloading of printing plates takes place whilst the secondary modules are separating from the primary module and moving into their non-operative positions. Similarly, the loading of printing plates onto the plate cylinders, once the leading edge of the printing plates have been inserted into their lock-up slots, is carried out whilst the secondary modules move back into their operative position with the primary module. The unloading process is preferably complete by the time that the secondary modules have reached their full extent of separation from the primary module, so that a person can walk in between each secondary module and the primary module and simply lift the unloaded printing plates off the extraction member from which they are left hanging. However, it will be appreciated that the unloading process may take less or more time than it takes for the secondary modules to fully separate from the primary module.

By performing the loading and/or loading tasks simultaneously with movement of the secondary modules towards or away from the primary module, the plating up and removal process is made even faster and means that the press can be brought back on-line very quickly.

Many modifications and variations of the invention falling within the terms of the following claims will be apparent to those skilled in the art and the foregoing description should be regarded as a description of the preferred embodiments only.

1. A method of controlling a printing unit comprising a plurality of printing couple pairs, each printing couple pair comprising a plate cylinder and a blanket cylinder and an inking system associated with each printing couple pair operable to supply ink to printing plates mounted on the plate cylinders of said printing couple pairs, the printing unit comprising a primary module carrying the printing couple pairs and, a pair of secondary modules carrying the inking systems, the secondary modules being movable relative to the primary module from an operative into a non-operative position in which each secondary module is separated from the primary module, the printing unit further comprising apparatus for loading/unloading printing plates from the plate cylinders of the printing unit, wherein the method includes the step of unloading printing plates from the plate cylinders of the printing unit using said apparatus whilst the secondary modules are moving relative to the primary module into their non-operative positions.

2. A method according to claim 1, wherein each printing plate has a leading and trailing edge which locate in respective lock-up slots in the plate cylinders, the step of unloading printing plates from the plate cylinders of the printing unit including the steps of:
(d) extracting the trailing edge of the printing plates from a lock-up slot in the plate cylinder;
(e) partially extracting the leading edge from a lock up slot of a plate cylinder and,
(f) rotating the plate cylinder so that an extraction member engages a portion of the leading edge of the printing plate protruding from the lock up slot following its partial extraction, to remove the printing plate from the plate cylinder and leave the removed plate, hanging by its leading edge, on the extraction member.

3. A method according to claim 2, wherein the removed plates are left hanging from the extraction member by the time separation of the secondary module from the primary module is complete.

4. A method according to claim 2, wherein the method includes the step of rotating the plate cylinders into a predetermined position following removal of the printing plates therefrom to facilitate the mounting of a further set of printing plates thereto prior to movement of the secondary modules back into their operative position with the primary module.

5. A method according to claim 4, wherein the mounting of a further set of printing plates includes the step of manually inserting the leading edge of the printing plates into a leading edge lock up slot in the plate cylinders and operating the printing plate loading/unloading apparatus to insert the trailing edge into the trailing edge lock up slot.

6. A method according to claim 5, including the step of operating the printing plate loading/unloading apparatus to insert the trailing edge of the printing plates into their respective trailing edge lock up slots as the secondary modules move back into their operative positions with the primary module.

7. A printing unit comprising a plurality of printing couple pairs, each printing couple pair comprising a plate cylinder and a blanket cylinder and an inking system associated with each printing couple pair operable to supply ink to printing plates mounted on the plate cylinders of said printing couple pairs, the printing unit comprising a primary module carrying the printing couple pairs and, a pair of secondary modules carrying the inking systems, the secondary modules being movable relative to the primary module from an operative into a non-operative position in which each secondary module is separated from the primary module, the printing unit further comprising apparatus for loading/unloading printing plates from the plate cylinders of the printing unit, wherein the printing unit further comprises control means operable to initiate operation of the apparatus for loading/unloading printing plates from the plate cylinders of the printing unit to unload printing plates therefrom when the secondary modules move relative to the primary module into their non-operative positions.

8. A printing unit according to claim 7, wherein the printing plates each have leading and trailing edges located in lock-up slots in the plate cylinders, the apparatus for loading/unloading printing plates comprising means for partially extracting the leading edge of a printing plate from a lock-up slot subsequent to extraction of trailing edge from its lock up slot and, an extraction member for engaging, as the printing cylinder rotates, a portion of the leading edge of the printing plate protruding from the lock up slot following its partial extraction, to complete the removal of the printing plate from the printing cylinder and leave the unloaded plate, hanging by its leading edge, on the extraction member.

9. A printing unit according to claim 8, wherein the apparatus is configured so that unloaded printing plates are hanging from the extraction member by the time separation of the secondary modules from the primary module is complete.

10. A printing unit according to claim 7, wherein the control means is configured to rotate the plate cylinders into a predetermined position following unloading of the printing plates to facilitate the mounting of a further set of printing plates thereto prior to movement of the secondary modules back into their operative position with the primary module.

11. A printing unit according to claim 10, wherein the control means is operable to control the printing plate loading/unloading apparatus to insert the trailing edge of the printing plates into the trailing edge lock up slot following manual insertion of the leading edge lock up slot.

12. A printing unit according to claim 11, wherein the control means is operable to initiate operation of the printing plate loading/unloading apparatus, to insert the trailing edge of the printing plates into their respective trailing edge lock up slots, as the secondary modules move back into their operative positions with the primary module.

13. A method for unloading printing plates with the apparatus of claim 1.

14. (canceled)
